(19) United States
(12) Patent Application Publication
(10) Pub. No.: US 2025/0362690 A1
(43) Pub. Date: Nov. 27, 2025

(54) METHOD FOR DETERMINING THE POSE OF A PALLET RELATIVE TO AN INDUSTRIAL TRUCK, AND INDUSTRIAL TRUCK

(71) Applicant: JUNGHEINRICH AKTIENGESELLSCHAFT, Hamburg (DE)

(72) Inventors: Dennis FLOTTRAN, Breitenfelde (DE); Maximilian FRÄNKEL, Wettin-Löbejün (DE); Heiko NIERMANN, Ergolding (DE); Peter HOFMANN, Hamburg (DE); Dominik MEINZER, München (DE)

(21) Appl. No.: 19/213,786

(22) Filed: May 20, 2025

(30) Foreign Application Priority Data
May 22, 2024 (DE) 10 2024 114 325.8

(51) Int. Cl. G05D 1/667; B66F 9/075; G05D 107/70; G05D 111/10; G05D 111/20

(52) U.S. Cl. CPC G05D 1/667; B66F 9/0755; G05D 2107/70; G05D 2111/17; G05D 2111/20

(57) ABSTRACT

A method for determining the pose of a pallet relative to an industrial truck that has a pair of fork arms with a first and a second fork arm and a first distance measuring means that is arranged in the region of a fork tip on the first fork arm and preferably directed towards a fork gap, wherein the pallet has an outer block, outer web, center block or web,

characterized by the steps of:
inserting the industrial truck into the pallet so that the first and second fork arms enter into the pallet,
determining multiple first distance measurement values with the first distance measuring means to the outer block, outer web, center block or web of the pallet during insertion,
calculating a degree of offset from at least one first distance measurement value and/or a degree of tilt from the difference between at least two first distance measurement values.

### CROSS-REFERENCE TO RELATED APPLICATION

This application claims priority from German Patent Application No. 10 2024 114 325.8, filed May 22, 2024, which is also incorporated herein by reference in its entirety.

The invention relates to a method for determining the pose of a pallet relative to an industrial truck, as well as an industrial truck.

Industrial trucks can be used to pick up pallets with fork arms. For this purpose, in the context of an insertion process, an industrial truck is moved relative to a pallet in such a way that the fork arms of the industrial truck enter the pallet so that after the insertion process, a center block or web of the pallet is arranged between the fork arms, or an outer block or outer web is arranged next to one of the fork arms. The fork arms can then be lifted with the pallet, and the industrial truck can be moved together with the pallet. To ensure great safety during lifting and the subsequent journey, a pallet should lie as centrally as possible on the fork arms and should also not be rotated relative to the fork arms. Otherwise, an unfavorable load distribution could occur which could endanger the operational safety, in particular the tipping stability, of the industrial truck. In the case of autonomously or automatically guided vehicles, it can also be necessary for the position determination to be carried out redundantly in order to ensure procedurally reliable operation.

In addition, for the most reproducible picking up and setting down of pallets using autonomous or automated industrial trucks, it is desirable if the pallet is located as centrally as possible on the load forks since this allows the position of the pallet to be determined as accurately as possible after being transported and set down by the industrial truck, and accordingly the pallet position can be optimally approached after setting down, for example by another autonomous or automated industrial truck.

Proceeding therefrom, the invention is based on the object of ensuring safe operation of an industrial truck during the handling of pallets.

The object is achieved by a method according to claim 1 and an industrial truck according to claim 11. Advantageous embodiments are the subject matter of the dependent claims and the following description.

The method according to the invention serves to determine the pose of a pallet relative to an industrial truck, wherein a pose is characterized by a position and an orientation. In other words, the method serves to determine the distance of the pallet from the industrial truck as well as a difference in orientation between the industrial truck and pallet.

The industrial truck has a pair of fork arms with a first and a second fork arm.

A first distance measuring means, which is preferably directed towards a fork gap, is arranged in the region of a tip of the first fork arm.

During the method, the industrial truck is inserted into the pallet. To do this, it is moved relative to the pallet so that the fork arms, which are free of the pallet at the beginning, increasingly enter the pallet until the pallet is finally completely positioned on the fork arms. The pallet has an outer block, outer web, center block or web, which can preferably be arranged below a pallet top which is designed to pick up a load. In so doing, the start of an insertion process within the meaning of the invention can be characterized in particular by the point in time from which the outer block, outer web next to the fork arms or the center block or web of the pallet is arranged between the fork arms.

During insertion, multiple distance measurement values are taken with the first distance measuring means. These represent the distance between the first distance measuring means and the outer block, outer web, center block or web, provided that the outer block or outer web is arranged next to the first fork arm, or the center block or web is arranged between the first distance measuring means and the opposite second fork arm or otherwise, the distance to the nearest object in an environment of the industrial truck or the distance between the first distance measuring means and the opposite, second fork arm.

After multiple first distance measurement values have been taken, a degree of offset and/or a degree of tilt are calculated. The degree of offset is calculated from at least one first distance measurement value. If only a first distance measurement value is used for the calculation, the degree of offset corresponds to this first distance measurement value. If multiple first distance measurement values are used, the degree of offset can be equal to one of the first distance values, their sum, the arithmetic mean, or the median. The degree of offset allows conclusions to be drawn as to whether the pallet was placed centrally on the fork arms. The calculation can take place during insertion or afterwards.

To calculate the degree of tilt, the difference between at least two first distance measurement values is calculated. If the pallet has a tilt relative to the fork arms, the distance between the center block or web and the first distance measuring means gradually decreases or increases. The presence of a difference between two first distance measurement values therefore allows the conclusion that there is a tilt. If multiple first distance measurement values are used, the differences between two first sequentially measured distance measurement values are calculated. The degree of tilt can then be calculated by calculating the arithmetic mean or median of the multiple differences, wherein the mean or median then corresponding to the degree of tilt. The degree of tilt indicates whether the pallet has a tilt relative to the fork arms.

If the outer block, outer web, center block or web does not extend completely or continuously over the length of the pallet, this can result in relatively large deviations arising between the first distance measurement values, even during a continuous insertion process in which the distance between the pallet and industrial truck continuously decreases. These deviations occur when the first distance measuring means no longer measures the distance between the first distance measuring means and the outer block, outer web, center block or web, but rather the distance to the environment or the opposite fork arm. Accordingly, the deviations correspond to the distance between the side of the center block or web facing the first distance means and the fork arm opposite the distance measuring means, i.e., at least the thickness of the center block or web. Then only the first distance measurement values taken while the center block or web was between the first distance measuring means and the second fork arm are used to calculate the degree of offset and/or degree of tilt. This can be determined by comparing the first distance measurement values with each other and using only those that do not have any deviations that at least correspond to the thickness of the center block or web for the calculation.

The degree of offset and/or the degree of tilt allow conclusions to be drawn as to whether the pallet is offset relative to the fork arms or rotated relative to them. As explained at the beginning, both are detrimental to operational safety.

As soon as a degree of offset and/or degree of tilt has been determined that is too large, a corresponding decision can be made and, for example, the industrial truck can be withdrawn from the pallet, or the lifting of the fork arms can be prevented.

The provision of the degree of offset and/or degree of tilt accordingly allows the operational safety of a corresponding industrial truck to be increased by applying the method.

Preferably, therefore, in additional method steps, a determined degree of offset and/or degree of tilt is compared with a threshold value and, if the threshold value is exceeded, the industrial truck is withdrawn from the pallet, the industrial truck is stopped, or the lifting of the fork arms is prevented.

Furthermore, an arrangement in which the first distance measuring means is arranged on the fork gap ensures that the first distance measuring means is better protected and also reduces susceptibility to interference. An outward-facing distance measuring means allows the method to be carried out even on pallets without a center block or web.

In one embodiment of the method according to the invention, the industrial truck has a steered wheel as well as a drive motor. The drive motor drives the steered wheel so that the industrial truck can be both steered and moved thereby. In an additional method step, a steering angle of the steered wheel and/or a control of the drive motor is changed based on the degree of offset and/or the degree of tilt. In this way, a correction is possible so that at the end of the insertion process, the pallet is both placed in the middle on the fork arms and aligned straight thereto. In this embodiment, the first distance measurement values are therefore preferably taken before the conclusion of the insertion process, and the degree of offset and/or the degree of tilt are also calculated before the conclusion of the insertion process.

In one embodiment of the invention, the industrial truck has a second distance measuring means which is arranged in the region of a fork tip of the second fork arm and is preferably directed towards the fork gap or outwards. In an additional method step, the second distance measuring means is used to measure multiple distance measurement values which indicate the distance of another outer block or outer web of the pallet to the second distance measuring means or of the center block or web of the pallet to the second distance measuring means. Therefore, in this embodiment as well, only those second distance measurement values are used which are determined when the second distance measuring means is arranged next to the additional outer block or outer web or between the second distance measuring means and the first fork arm of the center block or web.

The second distance measurement values are used in the calculation of the degree of offset and/or degree of tilt. A second distance measurement value can be used to calculate the degree of offset. The amount of the second distance measurement values can also be added to the first distance measurement values, or an average value can be calculated from the amounts of the first and second distance measurement values. To calculate the degree of tilt, the differences between consecutive second distance measurement values are calculated, as also with the first distance measurement values. The difference or the differences can then be used alone or together with the differences calculated from the first distance measurement values to calculate the degree of tilt, wherein for example addition or averaging can be performed.

By using second distance measurement values, more information is available for calculating the degree of offset and/or degree of tilt than is the case when only first distance measurement values are used. The thereby increased amount of information can improve the accuracy of the calculation of the degree of offset and/or degree of tilt.

According to one embodiment, the industrial truck has a third distance measuring means which is arranged on one of the fork arms and is preferably directed towards the fork gap or outwards. The third distance measuring means has a distance to the fork tip of the fork arm that is greater than a length of the pallet. The third distance measuring means is therefore mounted further away from the fork tips than is the case with the first and second distance measuring means.

In additional method steps, multiple third distance measurement values are measured with the third distance measuring means to the outer block, outer web, the additional outer block, the additional outer web, center block or web of the pallet during insertion. If a change in the third distance measurement values is determined that corresponds to at least one thickness of the outer block, outer web, center block or web, the fork arms are lifted. For this purpose, the third distance measurement values, which are measured consecutively in time, are compared with each other. If a difference is found between two distance measurements that is at least equal to the thickness of the outer block, outer web, center block or web, this corresponds to the change. During the insertion process, said change occurs when the outer block, outer web, center block or web passes the third distance measuring means and as a result, said measuring means no longer measures a distance that corresponds to its distance to the environment or its distance to the opposite fork arm, but measures a distance that corresponds to the distance to the outer block, outer web, center block or web and is significantly smaller. The distance is reduced by at least the thickness of the passing outer block, outer web, center block or web, but usually significantly more.

A change in the third distance measurement values that corresponds to at least the thickness of the outer block, outer web, center block or web indicates during the insertion process that the outer block, outer web, center block or web has passed the third distance measuring means. Because the third distance measuring means has a distance to the fork tip that is greater than the length of the pallet, this also means that the pallet is completely positioned on the fork arms. Only when this is the case can the pallet be lifted safely. With this embodiment, operational safety is therefore further increased.

According to a further embodiment, in an additional method step, multiple first, second and/or third distance measurement values are determined at a point in time after the fork arms have been lifted. It is then determined whether a change in the distance measurement values is determined that corresponds at least to the thickness of the outer block, outer web, center block or web. For this purpose, the distance measurement values of the first, second and/or third distance measuring means can be evaluated. Whether a change is determined that corresponds at least to the thickness of the outer block, outer web, center block or web is carried out analogously to the description of the previous embodiment. If a change in the distance measurement values is determined that corresponds to at least one thickness of the outer block, outer web, center block or web, movement of the industrial truck is stopped or prevented. If such a change occurs, it specifically means that the pallet has slipped. Safe continued operation is then no longer possible.

According to an additional embodiment, the third distance measurement value is used when calculating the degree of offset and/or the degree of tilt. The corresponding calculations are carried out as described in the embodiment according to which the second distance measurement value is used in addition to calculate the degree of offset and/or the degree of tilt. The accuracy of the method is also increased by using the third distance measurement value when calculating the degree of offset and/or degree of tilt.

According to one embodiment, a corresponding target value is subtracted from the distance measurement values to calculate the degree of offset. The target value can therefore in particular be subtracted from the first, second and/or third distance measurement values. The target value corresponds to a distance at which the outer blocks or webs are positioned relative to the fork arms as desired, preferably at the same distance therefrom, or the center block or web is arranged as desired, preferably centrally between the fork arms. As soon as the degree of offset value indicates a value other than zero, there is a difference between the measured distance value and target value, whereby it can be concluded that the fork arms are not positioned as desired. By using a target value, it is possible to quickly and easily determine whether the pallet is in the desired position relative to the fork arms.

According to an additional embodiment, the industrial truck has a fork back from which the fork arms protrude, and a fourth distance measuring means which is designed to measure a distance between the fork back and a pallet. The fourth distance measuring means can preferably be arranged on the fork back.

In additional method steps, multiple fourth distance measurement values between the fork back and the pallet are measured with the fourth distance measuring means during insertion. This means that the distance of the pallet that is to be lifted later to the fork back is known. The fork arms are only lifted if the last measured fourth distance measurement value is less than a maximum pickup distance. The maximum pickup distance specifies maximum distance that the pallet may have from the fork back. If this distance is exceeded, the pallet is not yet close enough to the fork back and it may not yet be possible to lift the pallet safely. In this case, the measurements with the fourth distance measuring means are carried out independently from the measurements with the other distance measuring means. This allows the given distance measuring means to be designed accordingly easily.

Preferably, fourth distance measurement values are taken at points in time at which first, second or third distance measurement values are taken. When calculating the degree of tilt, a difference between any two first, second or third distance measurement values is also divided by the given difference between the two fourth distance measurement values that were determined at the points in time at which the given first, second or third distance measurement values were determined. In this way, relative distance differences are used in the calculation of the degree of tilt, wherein the reference for calculating the relative values is the distance between the driving positions in which the industrial truck was located when the given first, second or third distance measurement values were determined. This reference to the route makes it possible to calculate a quantifiable angle as a degree of tilt by applying simple trigonometric functions.

According to an additional embodiment, the industrial truck has a travel path measuring means. This is designed to measure the travel path of the industrial truck. It is preferably a measuring means that measures the revolutions of the drive motor or the driven wheel. Such a measuring means can also be called an odometry measuring means.

In an additional method step, a travel path measurement value is measured with the travel path measuring means during the insertion. In so doing, the beginning of the insertion can be determined by the outer block, outer web, center block or web that passes the first distance measuring means. The fact that the center block or web has passed the first distance measuring means can be determined by the first distance measuring means if it detects a change in the first distance measurement value that is at least as large as the thickness of the outer block, outer web, center block or web.

The fork arms are only lifted if the travel path measurement value is greater than a minimum travel path value. The minimum travel path value corresponds to at least the length of the pallet. If the travel path at least corresponds to the minimum travel path value, this means that the fork arms have entered far enough into the pallet that the pallet is completely on the fork arms and can be lifted. Measuring the travel path and comparing it with a minimum travel path value thereby further increases operational safety.

Preferably, travel path measurement values are taken at the points in time at which the first, second or third distance measurement values are measured. When calculating the degree of tilt, a difference between any two first, second or third distance measurement values is also divided by the given difference between the two fourth travel path measurement values that were determined at the points in time at which the given first, second or third distance measurement values were determined. In this way as well, it is possible to use angles to calculate the degree of tilt.

Furthermore, this embodiment is preferably combined with the embodiments in which the third or fourth distance measuring means are present and used in additional method steps in order to carry out corresponding measurements on the basis of which a decision is made as to whether the pallet can be lifted. Such a combination of embodiments makes it possible for there to be redundant measurement results that indicate whether the pallet can be lifted safely. This can be necessary, in particular with regard to regulatory requirements. In this regard, if necessary the distance measurement with the fourth sensor can, for example, serve to make a decision about lifting, while the remaining sensors can only measure the offset and/or tilt with correspondingly high accuracy and low susceptibility to interference.

According to one embodiment, the measurements are each part of a continuous measurement. For this purpose, the distance measurement values are recorded and evaluated continuously, i.e., without interruption by the distance measuring means, wherein when using digital distance measuring means, even a measurement carried out at very short time intervals can be regarded as continuous. Such short intervals can range from less than a second to milliseconds. Alternatively, intermittent measurement with periodic or varying measurement intervals is also possible.

If measurements are continuous, more information about the pose of the pallet relative to the industrial truck is available. In particular, appropriate information on the degree of offset and/or the degree of tilt is available at any point in time. The evaluation can be carried out at any time. This allows for a particularly quick reaction to a change. This can also comprise a continuous correction of the steering angle of the steered wheel and/or the control of the drive motor. In this way, it can be particularly effectively ensured that the pallet is aligned centered and straight at the end of the insertion process.

It can be continuously monitored whether a change in the first, second and/or third distance measurement values occurs that corresponds to the thickness of the outer block, outer web, center block or web. As previously explained, such a change allows conclusions to be drawn as to whether the pallet has passed the corresponding distance measuring means or is positioned between it and the opposite fork arm.

The object underlying the invention is also achieved by an industrial truck having the features from claim 11. The industrial truck according to the invention has a pair of fork arms with a first as well as a second fork arm and a first distance measuring means which is arranged in the region of a fork tip on the first fork arm and is preferably directed towards the fork gap or outwards. An industrial truck according to the invention has a control device which is designed to instigate the determination of multiple first distance measurement values with the first distance measuring means to the outer block, outer web, center block or web during insertion of the industrial truck into a pallet which has an outer block, outer web, center block or web. In addition, the control device is designed to calculate a degree of offset from at least one first distance measurement value and/or a degree of tilt from the difference between at least two first distance measurement values.

With the industrial truck according to the invention, the method according to the invention can be carried out according to claim 1. The special features, technical effects and advantages associated with the method according to the invention have already been described. These statements also apply to the industrial truck according to the invention. In particular, the degree of offset determined with the industrial truck according to the invention can be used to determine whether the pallet is positioned centrally on the fork arms. The degree of tilt can be used to determine whether the pallet is arranged rotated on the fork arms. Based on this information, a decision can be made regarding the additional operation of the industrial truck and thereby increase operational safety.

According to one embodiment, the industrial truck has a steered wheel as well as a drive motor. The control device is designed to cause a change in the steering angle of the steered wheel and/or a control of the drive motor on the basis of the degree of offset and/or the degree of tilt. As already described above with regard to the corresponding embodiment of the method, in this embodiment of the industrial truck according to the invention, a correction can also be made during the insertion process based on the distance and/or the degree of tilt. This allows the pallet to be aligned centrally and straight on the fork arms after the insertion process and to be lifted safely.

According to an additional embodiment, the industrial truck has a second distance measuring means which is arranged in the region of a fork tip on the second fork arm and is directed towards the fork gap or outwards. Additionally or alternatively, it has a third distance measuring means that is arranged on one of the fork arms and directed towards the fork gap or outwards. In addition or alternatively to the second and/or third distance measuring means, the industrial truck of this embodiment can also have a fork back from which the fork arms protrude, with a fourth distance measuring means arranged thereon, which is designed to measure a distance between the fork back and a pallet. According to this embodiment, the industrial truck can alternatively or additionally have a travel path measuring means.

Depending on whether the industrial truck has a second, third and/or fourth distance measuring means and/or a travel path measuring means, the control device is designed to cause the second, third and/or fourth measuring means to measure the distance and/or the travel path measuring means to carry out a travel path measurement and to take the measurements determined in the process into account when calculating the degree of offset and/or the degree of tilt.

An industrial truck according to this embodiment is designed to carry out a method according to claims 3 to 9. Which of these methods can be carried out with the industrial truck of this embodiment depends in particular on which measuring means the industrial truck has. Accordingly, the special features, technical effects and advantages already described for these methods also accordingly apply to a corresponding industrial truck.

According to one embodiment, the first, second and/or third distance measuring means are each designed as a laser sensor. Alternatively or additionally, the fourth distance measuring means is designed as a lidar or ultrasonic sensor.

Laser sensors can in particular be designed so that they measure along a straight line. This makes it possible to trace where on this straight line the center bock or web is arranged when a distance measurement value is determined. This allows an exact determination of the center block or web relative to the given distance measuring means. This makes it possible in particular to determine particularly precisely when the outer block, outer web, center block or web has passed the given sensor. When combined with a measurement of the travel using the travel path measuring means, the position of the center block or web and accordingly of the pallet can be determined particularly precisely.

Using lidar or ultrasonic sensors, the distance between the pallet and the fourth distance measuring means can be reliably determined. They can be characterized in particular by a conical or fan-shaped measuring range which enables easy detection of a pallet in the vicinity of the industrial truck.

It is preferable to use the measuring means to measure continuously. What is understood as continuous in this document with regard to the cited measuring means has already been explained above and applies accordingly to this embodiment of the industrial truck according to the invention, as do the corresponding effects.

The invention is explained in more detail below with reference to an exemplary

embodiment that is shown in the accompanying drawings, in which:

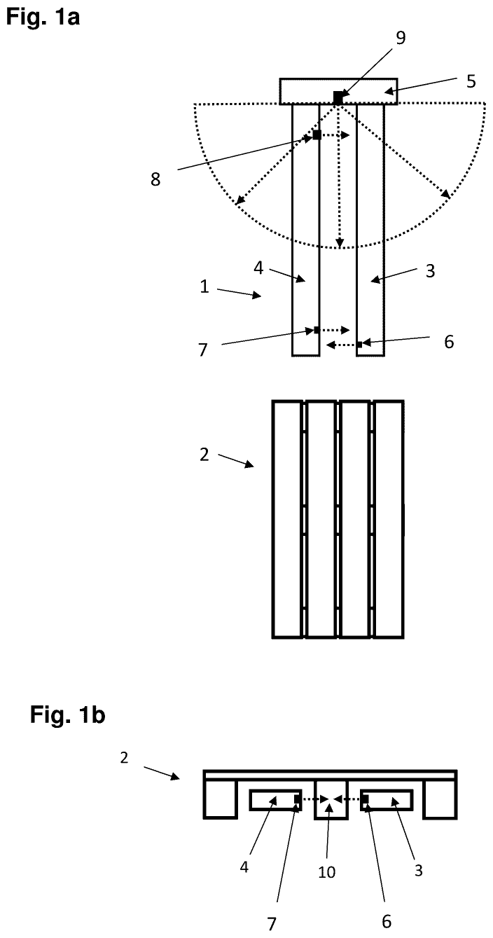

FIG. 1a shows a schematic view of a load handling means of an industrial truck according to the invention and a pallet;

FIG. 1b shows a schematic view of a pallet on fork arms of an industrial truck according to the invention;

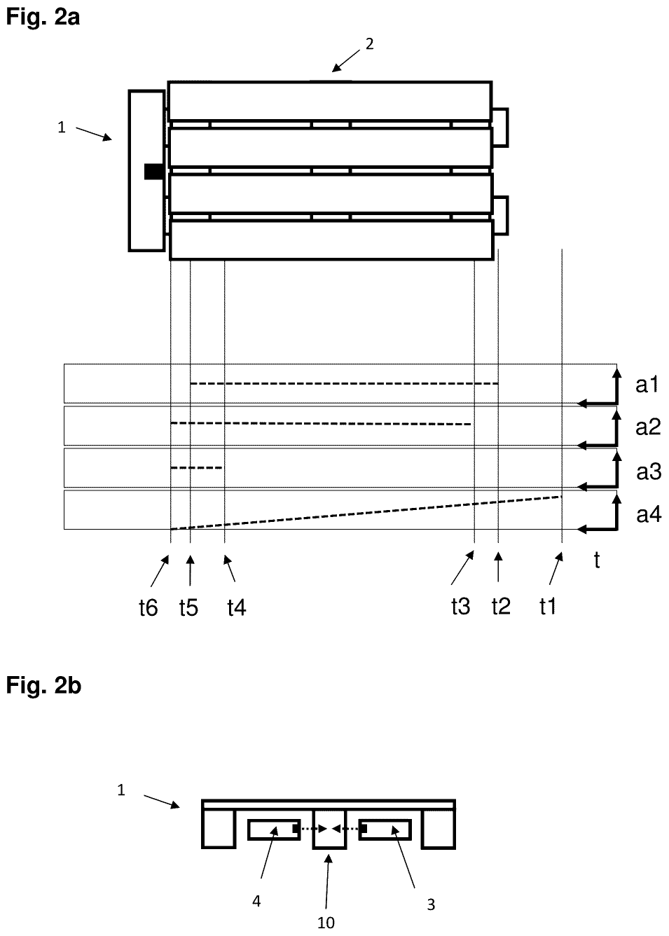

FIG. 2a shows schematic representations of distance measurement value curves with a central position and straight alignment of the pallet;

FIG. 2b shows a schematic representation of a pallet placed centrally on the fork arms;

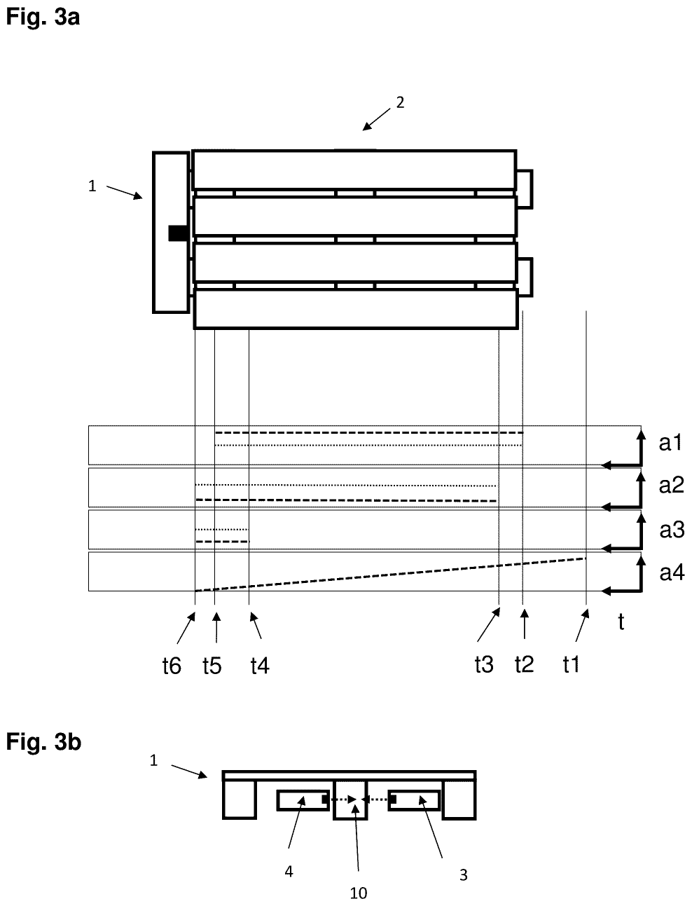

FIG. 3a shows schematic representations of distance measurement value curves when the pallet is offset;

FIG. 3b shows a schematic representation of a pallet placed offset on the fork arms;

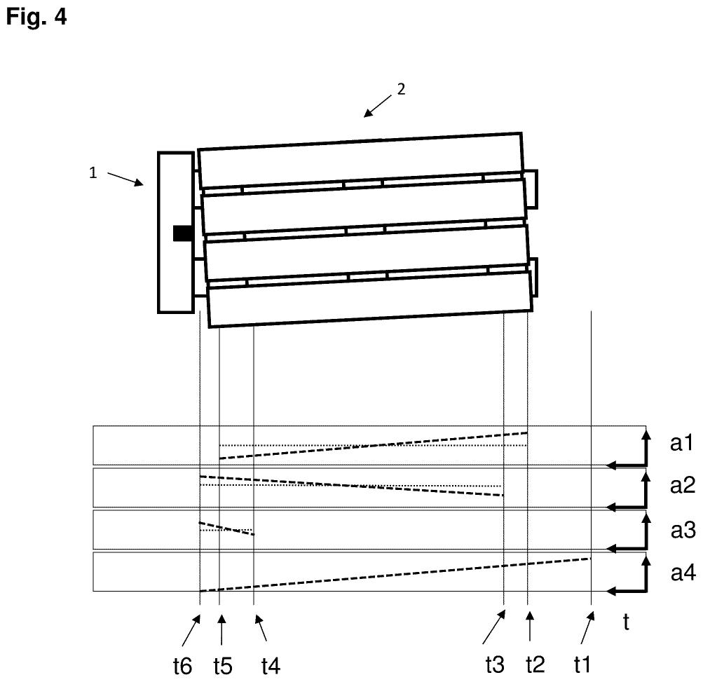

FIG. 4 shows schematic representations of distance measurement value curves with a rotated alignment of the pallet.

FIG. 1a shows a schematic view of a load handling means 1 of an industrial truck according to the invention and a pallet 2 from above. The load handling means 1 has a first and second fork arm 3, 4 which are arranged parallel and protrude from the fork back 5. The first distance measuring means 6 is arranged on the first fork arm 3 and is directed towards the gap between the fork arms 3, 4. The second distance measuring means 7 is arranged on the second fork arm 4 and is directed towards the gap between the fork arms 3, 4. The first and second distance measuring means 6, 7 are each arranged in the region of the fork tips, i.e., at a relatively large distance from the fork back 5. In addition to the second distance measuring means 7, a third distance measuring means 8 is also arranged on the second fork arm 4, which is also directed towards the gap between the fork arms 3, 4. The third distance measuring means 8 is arranged in the region of the fork back 5. The three distance measuring means 6, 7, 8 are designed as laser sensors that measure along a straight line, which is indicated by the dashed arrows. The alignment of the arrows shows that the measuring ranges are aligned perpendicular to the fork arms 3, 4. A fourth distance measuring means 9 is also arranged on the fork back 5 and is designed as a lidar sensor and accordingly has a fan-shaped measuring range which is also shown by dashed lines and covers the region in front of the fork arms 3, 4. When the industrial truck approaches the pallet 2, the fourth distance measuring means 9 is able to determine the distance between the fork back 5 and the pallet 2.

FIG. 1b shows a schematic view of the pallet 2 on the fork arms 3, 4 from the front. From the view, it can be seen that the pallet has a center block 10 which is arranged in the middle of the pallet. After an insertion process has been completed, the fork arms 3 and 4 are located next to the center block 10. The first and second distance measuring means 3, 4 then record a significantly shorter distance measurement value because they no longer measure the distance to the opposite fork arm 3, 4 but rather to the center block 10 arranged therebetween.

FIG. 2a shows schematic representations of distance measurement value curves with a center position and straight alignment of the pallet 2. For each of the four distance measuring means 6, 7, 8, 9, a diagram is shown, which represents the given distance measurement value a1-a4 on a vertical axis and the time t on the horizontal axis. Time t describes an insertion process in which, at the beginning, the pallet 2 is not yet arranged on the load handling means 1 and, at its end, the pallet 2 is arranged on the load handling means 1 as shown in FIG. 2a.

During the insertion process, the industrial truck with its load handling means 1 moves closer and closer to the pallet 2, wherein it has a constant speed. This is illustrated by the distance measurement value a4 shown in dashed lines, which decreases constantly over time t, wherein the fourth distance measuring means 9 registers the pallet from time t1. From time t2, the center block 10 passes the first distance measuring means 6 whose distance measurement value a1 immediately jumps to a middle value. From time t3 onwards, the same happens with the second distance measuring means 7, and from time t4 onwards, with the third distance measuring means 8 as well. From time t5, the pallet has already reached so close to the fork back 5 that the first distance measuring means again measures a very high distance measurement value which corresponds to the distance to the opposite fork arm 4 and lies outside the displayed measuring range. At time t6, pallet 2 has moved so close to the fork back 5 that the distance measurement value a4, which has dropped to the lower end of the scale, indicates that the maximum distance between the fork back 5 and pallet 2 which, for reliable picking up, must not be exceeded, has been reached. The pallet can now be lifted.

It is noticeable that the curves of the distance measurement values a1-a3 are aligned parallel to the horizontal axis of the diagrams. This is due to the central alignment of the pallet 2 relative to the fork arms 3, 4. FIG. 2b shows this in a schematic representation, wherein the pallet 2 placed centrally on the fork arms 3, 4, with the center block 10 arranged exactly between the fork arms 3, 4, is clearly visible.

FIG. 3a shows schematic representations of distance measurement value curves when the pallet is offset. The representation of the distance measurement values a1-a4 corresponds to that in FIG. 2a. However, in the insertion process shown in this figure, the pallet 2 is not centered on the fork arms 3, 4 after the insertion process is completed. Rather, it has an offset so that the center block 10 is located closer to the second fork arm 4 than to the first fork arm 3, as can be seen from FIG. 3b. For this reason, the first distance measuring means 6 continuously measures a larger distance measurement value a1 than in the central case shown in FIG. 2a, wherein the distance measurement value a1 of the central case is also shown with a thinner line thickness for comparison. The same accordingly applies to the second and third distance measuring means 7, 8. Due to the fact that the distance measurement values a1-a3 in the case shown in this figure differ from the previously shown distance measurement value curves, it can be determined that the pallet has an offset.

For example, by calculating an average of the recorded distance measurement values a1-a3 of a given sensor, a degree of offset can be determined which expresses that an offset is present. Individual values can also be accepted for the degree of offset, subject to a reduction in accuracy. The distance measurement values a1-a3 can also be evaluated together. To do this, the difference to the thinly displayed values of a centrally arranged pallet can first be subtracted, and then an average can be determined. This also makes it possible to quantitatively determine the offset. The distance measurement value curves of the central case can be regarded as target values.

FIG. 4 shows schematic representations of distance measurement value curves when the pallet 2 is in a rotated alignment relative to the industrial truck. For reference, the curves are again marked with a thinner line width according to the centrally positioned and straight aligned target case. The shown distance measurement values a1 to a3 illustrate that a change in the recorded distance measurement values a1-a3 always takes place during the insertion process. Due to the tilt of the pallet 2, the center block 10 is located close to the first distance measuring means 6 at the beginning of insertion and further away from it at the end, which is evident from the falling progression of the first distance measurement value a1. The second and third distance measuring means 7, 8 arranged on the second fork arm 5, however, show an increasing progression of the distance measurement values a2, a3 due to the tilt.

A degree of tilt can be calculated which indicates the tilt of the pallet 2 in relation to the load handling means 1 by calculating the difference between two distance measurement values a1, a2, a3 recorded at different times t by the same distance measuring means 6, 7, 8. The amount of the differences determined in this way can also be added together, or the mean value can be calculated in order to obtain a more precise indication of the degree of tilt.

In the present exemplary embodiment, continuous measurements were carried out which were not only measured at discrete points in time, but continuously or at such short intervals that this is irrelevant for the representation. It is then also possible to calculate the given curves of change, i.e., the time derivatives of the distance measurement values a1-a3 and to evaluate them, for example by averaging, in order to determine the degree of tilt.

### REFERENCE SIGNS

1 Load handling means

2 Pallet

3 First fork arm

4 Second fork arm

5 Fork backs

6 First distance measuring means

7 Second distance measuring means

8 Third distance measuring means

9 Fourth distance measuring means

10 Center block

a1 First distance measurement value

a2 Second distance measurement value

a3 Third distance measurement value

a4 Fourth distance measurement value

t Time

1. A method for determining the pose of a pallet relative to an industrial truck that has a pair of fork arms with a first and a second fork arm, and a first distance measuring means that is arranged in the region of a fork tip on the first fork arm and preferably directed towards a fork gap, wherein the pallet has an outer block, outer web, center block or web,
comprising the steps of:
inserting the industrial truck into the pallet so that the first and second fork arms enter into the pallet,
determining multiple first distance measurement values with the first distance measuring means to the outer block, outer web, center block or web of the pallet during insertion,
calculating a degree of offset from at least one first distance measurement value and/or a degree of tilt from the difference between at least two first distance measurement values.

2. The method according to claim 1, wherein the industrial truck has a steered wheel and a drive motor and, in an additional method step, a steering angle of the steered wheel and/or a control of the drive motor is changed based on the degree of offset and/or the degree of tilt, so that the fork arms are aligned centrally and straight relative to the pallet after the insertion process.

3. The method according to claim 1, wherein:
the industrial truck has a second distance measuring means which is arranged in the region of a fork tip of the second fork arm and is preferably directed towards the fork gap or outwards,
multiple second distance measurement values are measured with the second distance measuring means to the outer block, outer web, center block or web of the pallet during insertion in an additional method step, and
the second distance measurement values are used when calculating the degree of offset and/or the degree of tilt.

4. The method according to claim 1, wherein:
the industrial truck has a third distance measuring means which is arranged on one of the fork arms, is preferably directed towards the fork gap or outwards, and has a distance to the fork tip of the fork arm which is greater than a length of the pallet, and in additional method steps,
multiple third distance measurement values are measured with the third distance measuring means to the outer block, outer web, center block or web of the pallet during insertion, and
the fork arms are lifted if a change in the third distance measurement values is determined which corresponds to at least a thickness of the center block or web.

5. The method according to claim 4, wherein in additional method steps:
at a point in time after the fork arms have been lifted, multiple first, second and/or third distance measurement values are determined with the first, second and/or third distance measuring means, and.
a movement of the industrial truck is stopped or prevented if a change in the distance measurement values is determined that corresponds to at least the thickness of the outer block, outer web, center block or web.

6. The method according to claim 4, wherein the third distance measurement value is used when calculating the degree of offset and/or the degree of tilt.

7. The method according to claim 1, wherein to calculate the degree of offset, a corresponding target value is subtracted from the distance measurement values.

8. The method according to claim 1, wherein the industrial truck has a fork back from which the fork arms protrude, and a fourth distance measuring means which is designed to measure a distance between the fork back and a pallet, and in additional method steps,
multiple fourth distance measurement values between the fork back and the pallet are measured with the fourth distance measuring means during insertion, and
the fork arms are lifted if the last measured fourth distance measurement value is less than a maximum pickup distance.

9. The method according to claim 1, wherein the industrial truck has a travel path measuring means, and in additional method steps,.
a travel path measurement value is measured with the travel path measuring means during the insertion, and
the fork arms are lifted if the travel measurement is greater than a minimum travel path value.

10. The method according to claim 1, wherein the measurements are each part of a continuous measurement.

11. An industrial truck comprising a pair of fork arms with a first as well as a second fork arm and a first distance measuring means which is arranged in the region of a fork tip on the first fork arm and preferably directed towards the fork gap or outwards,
comprising a control device which is designed
to instigate the determination of multiple first distance measurement values with the first distance measuring means to the outer block, outer web, center block or web during insertion of the industrial truck into a pallet which has an outer block, outer web, center block or web, and
to calculate a degree of offset from at least one first distance measurement value and/or a degree of tilt from the difference between at least two first distance measurement values.

12. The industrial truck according to claim 12, wherein the industrial truck has a steered wheel as well as a drive motor, wherein the control device is designed to cause a change in the steering angle of the steered wheel and/or a control of the drive motor on the basis of the degree of offset and/or the degree of tilt.

13. The industrial truck according to claim 11, wherein the industrial truck:
has a second distance measuring means which is arranged in the region of a fork tip on the second fork arm and is preferably directed towards the fork gap or outwards,
has a third distance measuring means that is arranged on one of the fork arms and is preferably directed towards the fork gap or outwards,
has a fork back from which the fork arms protrude, with a fourth distance measuring means arranged thereon, which is designed to measure a distance between the fork back and a pallet, and/or
has a travel path measuring means,
wherein the control device is designed to cause the second, third and/or fourth distance measuring means to carry out a distance measurement value and/or the travel path measuring means to carry out a travel path measurement and to take the measurements determined in this way into account when calculating the degree of offset and/or degree of tilt.

14. The industrial truck according to claim 11, wherein the first, second and/or third distance measuring means are each designed as a laser sensor, and/or the fourth distance measuring means is designed as a lidar or ultrasonic sensor.
